(19) United States
(12) Patent Application Publication
(10) Pub. No.: US 2026/0155145 A1
(43) Pub. Date: Jun. 4, 2026

(54) INFORMATION PROCESSING DEVICE

(71) Applicant: TOYOTA JIDOSHA KABUSHIKI KAISHA, Toyota-shi (JP)

(72) Inventor: Yuma ISHINO, Tokyo (JP)

(73) Assignee: TOYOTA JIDOSHA KABUSHIKI KAISHA, Toyota-shi (JP)

(21) Appl. No.: 19/327,569

(22) Filed: Sep. 12, 2025

(30) Foreign Application Priority Data
Dec. 2, 2024 (JP) 2024-209755

(51) Int. Cl. G10L 15/22; G06Q 30/01; G08B 23/00

(52) U.S. Cl. CPC G10L 15/22; G06Q 30/01; G08B 23/00

(57) ABSTRACT

An information processing device includes a control unit. The control unit is configured to: acquire negotiation information during a business negotiation with a customer by using one or more sensors; determine, based on the result of analyzing the negotiation information using machine learning, whether there is a sign of trouble in the business negotiation, and when determination is made that there is the sign of trouble, send an alert to a specific terminal.

### CROSS-REFERENCE TO RELATED APPLICATION

This application claims priority to Japanese Patent Application No. 2024-209755 filed on Dec. 2, 2024. The disclosure of the above-identified application, including the specification, drawings, and claims, is incorporated by reference herein in its entirety.

### BACKGROUND

### 1. Technical Field

The present disclosure relates to information processing devices.

### 2. Description of Related Art

Japanese Unexamined Patent Application Publication No. 2023-076413 (JP 2023-076413 A) discloses a technique for selecting documents that may contain information relevant to a response to a user's query input to a search model, and outputting the response.

### SUMMARY

There is a demand for systems that reduce the occurrence of trouble with customers during business negotiations and ensure the smooth progress of business negotiations.

An object of the present disclosure is to reduce the occurrence of trouble with customers during business negotiations.

An information processing device according to an embodiment of the present disclosure includes a control unit.

The control unit is configured to
acquire negotiation information during a business negotiation with a customer by using one or more sensors,
determine, based on a result of analyzing the negotiation information using machine learning, whether there is a sign of trouble in the business negotiation, and
upon determining that there is the sign of trouble, send an alert to a specific terminal.

The present disclosure can reduce the occurrence of trouble with customers during business negotiations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating the configuration of a system according to an embodiment of the present disclosure; and

FIG. 2 is a flowchart illustrating the operation of an information processing device according to the embodiment of the present disclosure.

### DETAILED DESCRIPTION OF EMBODIMENTS

Hereinafter, an embodiment of the present disclosure will be described with reference to the drawings.

The same or corresponding parts are denoted by the same signs throughout the drawings. In the following description of the embodiment, the description of the same or corresponding parts will be omitted or simplified as appropriate.

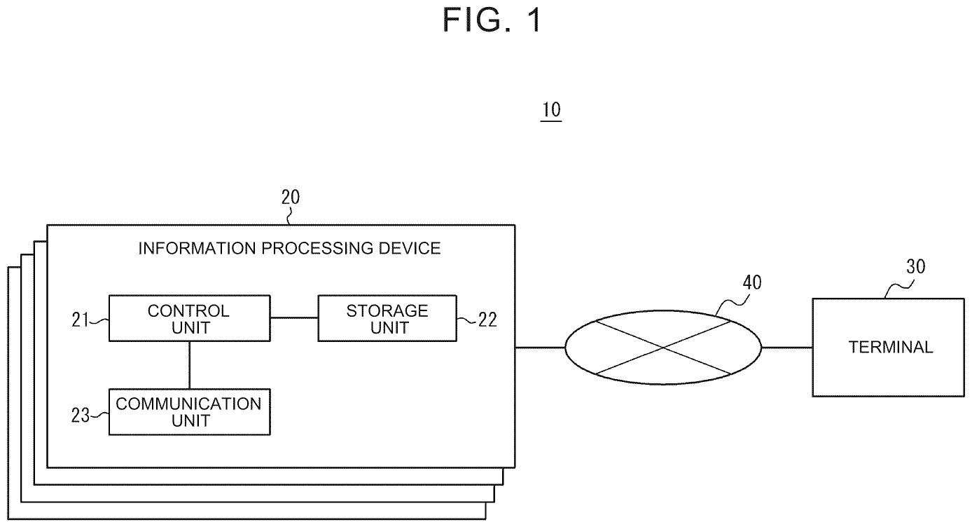

The configuration of a system 10 according to the present embodiment will be described with reference to FIG. 1.

The system 10 includes at least one information processing device 20 and at least one terminal 30.

The information processing device 20 is capable of communicating with the terminal 30 via a network 40.

The information processing device 20 is a terminal device installed at, for example, a dealership that sells vehicles. That is, part or all of the functions of the information processing device 20 are implemented on the terminal device. A vehicle salesperson at the dealership conducts negotiations with customers using the terminal device. The information processing device 20 is, for example, a mobile phone, a smartphone, a tablet, or a PC. “PC” stands for personal computer.

The terminal 30 is held by, for example, a manager of the dealership that sells vehicles. The terminal 30 may be, for example, a mobile phone, a smartphone, a tablet, or a PC. Information regarding the content of a business negotiation conducted by a vehicle salesperson is transmitted from the information processing device 20 to the terminal 30.

The network 40 includes the Internet, at least one WAN, at least one MAN, or any combination thereof. “WAN” stands for wide area network. “MAN” stands for metropolitan area network.

The overall configuration of the present embodiment will be described with reference to FIG. 1.

For example, dialog systems using information retrieval technologies such as RAG have been used in business negotiations. “RAG” stands for Retrieval-Augmented Generation. It is possible to generate a response to, for example, a question from a customer during a business negotiation by using such a dialog system.

Trouble may occur between a customer and a salesperson during a business negotiation. In particular, customer harassment during business negotiations has become a growing concern in recent years. Customer harassment refers to excessive and inappropriate behavior by customers toward employees, including abusive language, threats, and unreasonable demands. Implementing appropriate countermeasures against trouble such as customer harassment is essential to protect the mental and physical well-being of employees. One possible countermeasure may involve a dealership manager or the like monitoring the status of business negotiations conducted by employees and, when trouble occurs, going to the site (the sales floor) to intervene and resolve the situation. It is desirable that such trouble be addressed at an early stage and resolved before it escalates. However, when business negotiations with multiple customers are being conducted in parallel, it is difficult for the dealership manager to listen to each negotiation in real time, making it hard to detect the occurrence of trouble.

In the present embodiment, the information processing device 20 acquires negotiation information D1 during a business negotiation with a customer, using one or more sensors. For example, the negotiation information D1 may include verbal information such as the content, volume, and tone of speech of the customer and the employee during the business negotiation, and non-verbal information such as facial expressions and gestures of the customer and the employee during the business negotiation. The negotiation information D1 may also include biometric information of the employee. The information processing device 20 analyzes the negotiation information D1 using machine learning, and determines, based on the analysist result, whether there is a sign of trouble in the business negotiation. When the information processing device 20 determines that there is a sign of trouble, it sends an alert to the terminal 30.

In the present embodiment, an alert is issued when a situation with a high likelihood of trouble, such as customer harassment during a business negotiation, is detected. The alert is sent to the dealership manager. Accordingly, even when the manager is unable to listen to the negotiation in real time, the manager can still detect the occurrence of trouble and go to the site to intervene and resolve the situation. This increases the likelihood that trouble can be addressed promptly and appropriately. As a result, the occurrence of trouble with customers during business negotiations can be reduced.

The configuration of the information processing device 20 according to the present embodiment will be described with reference to FIG. 1.

The information processing device 20 includes a control unit 21, a storage unit 22, and a communication unit 23. The control unit 21 includes at least one processor, at least one programmable circuit, at least one dedicated circuit, or any combination thereof, and executes predetermined processing.

The storage unit 22 includes at least one semiconductor memory, at least one magnetic memory, at least one optical memory, or a combination of at least two of these. In the present embodiment, the storage unit 22 may store a database DB in which, for each of a plurality of vehicles, a model is registered in association with one or more attributes related to the model. The database DB will be described later.

The communication unit 23 includes at least one communication interface. In the present embodiment, the communication unit 23 communicates with the terminal 30.

The functions of the information processing device 20 are implemented by causing a processor, functioning as the control unit 21, to execute a program according to the present embodiment. That is, the functions of the information processing device 20 are realized by software.

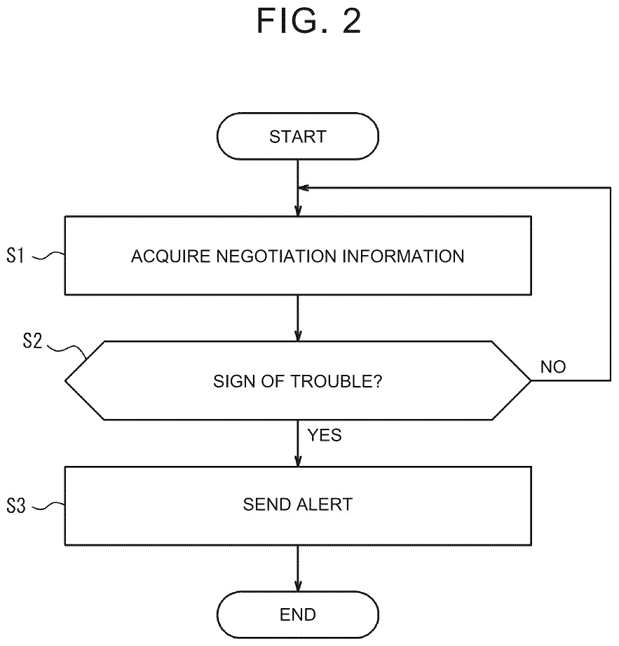

The operation of the information processing device 20 according to the present embodiment will be described with reference to FIG. 2. This operation corresponds to an information processing method according to the present embodiment. That is, the information processing method according to the present embodiment includes steps S1 to S3 shown in FIG. 2. Hereinafter, each step in the flowchart will be identified by “S” followed by a number.

In S1, the control unit 21 of the information processing device 20 acquires negotiation information D1. The negotiation information D1 may be acquired by any procedure. For example, an input unit may be provided in the information processing device 20, and one or more sensors, such as a microphone and a camera, that form part of the input unit may be used to monitor, in real time, voice during a business negotiation with a visiting customer, the customer's utterances, facial expressions, etc. The control unit 21 may then acquire these pieces of data as the negotiation information D1. Alternatively, one or more sensors such as a microphone and a camera may be provided externally to the information processing device 20, and the control unit 21 may acquire the negotiation information D1 by receiving, via the communication unit 23, information obtained by the one or more sensors.

In S2, the control unit 21 of the information processing device 20 determines, based on the negotiation information D1 acquired in S1, whether there is a sign of trouble in the business negotiation. Specifically, the control unit 21 analyzes the negotiation information D1 acquired in S1 using machine learning, and detects a sign of trouble. For example, the control unit 21 analyzes the content, volume, tone of the customer's speech, the customer's facial expressions, etc. included in the negotiation information D1 using machine learning such as natural language processing or keyword detection and, when a predetermined condition is satisfied, determines that there is a sign of trouble. For example, the control unit 21 may detect, as a sign of trouble, a negative keyword or expression such as “not happy,” “problem,” or “disappointed” in the customer's utterances included in the negotiation information D1. Any type of machine learning may be used. For example, any natural language processing techniques selected from large language models, NLP, intent recognition models, NER, and semantic search may be used either alone or in combination. “NLP” stands for Natural Language Processing. “NER” stands for Named Entity Recognition. The control unit 21 may estimate the customer's emotional state based on the volume and tone of the customer's speech, the customer's facial expressions, and the like indicated in the negotiation information D1, and may determine that there is a sign of trouble when a strong negative emotion such as anger or dissatisfaction is detected. Alternatively, the control unit 21 may analyze non-verbal signs such as the customer's gestures indicated in the negotiation information D1 and determine whether there is a sign of trouble. Alternatively, when the employee's tone of voice rises or the employee starts speaking faster during the business negotiation, the control unit 21 may determine that such a change indicates a sign of tension and/or stress, and may further determine that there is a sign of trouble.

As a modification of the present embodiment, the negotiation information D1 may include biometric information of the employee obtained during the business negotiation. The control unit 21 of the information processing device 20 may determine that there is a sign of trouble when the employee's biometric information satisfies a predetermined condition. This is based on the assumption that various changes may be observed in the biometric information of an employee who is subjected to customer harassment. Main changes in biometric information may include increases in heart rate and blood pressure, changes in respiration, muscle tension, and perspiration. Accordingly, in this modification, in S1, the control unit 21 of the information processing device 20 acquires, as the negotiation information D1, biometric information of the employee during the business negotiation, such as data on the employee's heart rate, blood pressure, and respiration. These pieces of data may be monitored, for example, using a wearable device such as a smartwatch worn by the employee. Then, in S2, when the biometric information included in the negotiation information D1 acquired in S1 satisfies the predetermined condition, the control unit 21 may determine that there is a sign of trouble and that the employee may possibly be experiencing customer harassment. For example, the control unit 21 may monitor, in real time, changes in the employee's heart rate, blood pressure, or respiratory pattern, and, when such changes satisfy a predetermined condition, may determine that they indicate a sign of trouble and that the employee may possibly be experiencing customer harassment. As one example, the control unit 21 may detect a sudden increase in the employee's heart rate or blood pressure, or shallower or more rapid breathing, as a sign of stress and/or tension, and may determine that the employee is possibly experiencing customer harassment. Furthermore, the control unit 21 of the information processing device 20 may determine that trouble has occurred when the state in which the employee's biometric information satisfies the predetermined condition continues for a certain period of time. For example, the control unit 21 may determine that trouble has occurred when the employee's elevated heart rate persists for five minutes or more. The control unit 21 may also determine a “degree of trouble” indicating the severity of the trouble, according to the duration of the state. That is, the longer the duration, the higher the degree of trouble may be determined to be.

According to this modification, monitoring the employee's biometric information in real time makes it possible to detect a sign of stress or tension in the employee. Therefore, it becomes possible to determine the possibility that the employee is experiencing customer harassment and to take prompt action. As a result, potential trouble can be addressed at an early stage, thereby reducing the occurrence of trouble with customers during business negotiations.

In vehicle sales negotiations, providing incorrect information to the customer regarding the vehicle's specifications, delivery date, or price may lead to trouble. For example, if an incorrect delivery date is communicated to the customer, the vehicle may not arrive by the date expected by the customer, which can result in a loss of customer trust and pose a risk to future business. In addition, if the customer suffers a loss due to a delay in delivery, they may file a claim for compensation. Therefore, comparing the information communicated by the employee to the customer, such as the specifications, delivery time, and price of the vehicle being considered in the business negotiation (the target vehicle), with the latest information on the target vehicle and detecting a difference therebetween is effective in reducing the risk of providing incorrect information on the target vehicle and in addressing potential trouble at an early stage.

Accordingly, in S2, the control unit 21 of the information processing device 20 may further refer to a database DB in which, for each of a plurality of vehicles, a model is registered in association with one or more attributes related to the model. The control unit 21 may analyze the negotiation information D1 by comparing the negotiation information D1 with the database DB using machine learning. In this case, it is assumed that the negotiation information D1 includes vehicle data indicating the model of the target vehicle and the values of the attributes related to the model. As a specific example, it is assumed that the model of the vehicle under consideration in the business negotiation is model X, and that the employee tells the customer during the negotiation, “The delivery time for model X is three months.” It should be noted that the “specific example” is not intended to limit the present disclosure but is provided to facilitate understanding the present embodiment. In this specific example, the negotiation information D1 includes the model of the target vehicle as “X,” with “delivery time” as an attribute of the model and “three months” as the value of the attribute. The control unit 21 of the information processing device 20 compares a spoken attribute value with a registered attribute value. The spoken attribute value is a value of an attribute that is spoken during the business negotiation and indicated in the vehicle data. The registered attribute value is a value of an attribute that is registered in the database DB for the same model as the model of the target vehicle indicated in the vehicle data. In the specific example described above, the model of the target vehicle indicated in the vehicle data is “X,” and the spoken attribute value is “delivery time: three months.” It is herein assumed that the value “five months” is registered as “delivery time” for the model “X” in the database DB. The control unit 21 searches the database DB and extracts, as the registered attribute value, the value “five months” registered as “delivery time” for the model “X” in the database DB. Since the spoken attribute value (“three months”) indicated in the vehicle data differs from the registered attribute value (“five months”) registered in the database DB, the control unit 21 determines that there is a sign of trouble. This configuration reduces the risk of providing incorrect information to the customer regarding the specifications, delivery time, or price of the target vehicle. Accordingly, the occurrence of trouble with customers during business negotiations can be reduced.

When it is determined in S2 that there is a sign of trouble, the process proceeds to S3. When it is determined in S2 that there is no sign of trouble, the process returns to S1, and the control unit 21 continues to acquire the negotiation information D1.

In S3, the control unit 21 of the information processing device 20 sends an alert W to a specific terminal. Specifically, the control unit 21 sends an alert W to the manager's terminal 30. Any form of alert may be used as the alert W as long as it is capable of notifying the manager of the occurrence of trouble. For example, the alert W may be an audio alert, a visual alert, or a vibration alert. The audio alert emits a warning sound such as a buzzer from the terminal 30. The visual alert displays a popup message, a warning icon, or the like on the screen of the terminal 30. The vibration alert draws attention by causing the terminal 30 to vibrate. The vibration alert is particularly effective in situations where an audio alert, a visual alert, or the like may be missed. Alternatively, the control unit 21 may send a message or the like to the terminal 30 as the alert W. For example, the control unit 21 may send, as the alert W, a message to the terminal 30 stating, “A sign of trouble has been detected during the business negotiation with customer Y. Please check the details.” These alerts W may be used either alone or in combination.

In S3, the control unit 21 of the information processing device 20 may send at least part of the negotiation information D1 to the terminal 30 along with the alert W. It is herein assumed that the negotiation information D1 includes voice data V obtained during the business negotiation. When it is determined in S2 that there is a sign of trouble, the control unit 21 may generate a summary of the business negotiation from the voice data V using, for example, a natural language processing technique. The control unit 21 then sends the generated summary, as part of the negotiation information D1, to the terminal 30 along with the alert W. The summary may objectively state the customer's concerns or dissatisfaction, such as “The customer has expressed concern about the vehicle's delivery time,” “The customer has raised questions regarding quality,” or “The customer feels that the price is high compared to competitors'products.” Alternatively, the summary may be an excerpt of key statements made by the customer. The summary may be in the form of text data or audio data. Sending the summary together with the alert W in this manner allows the manager who receives the notification to be informed in advance of the cause of the trouble etc. This makes it possible to respond to the trouble more quickly.

As described above, according to the present embodiment, an alert W is sent to a specific terminal when the occurrence of trouble is detected during a business negotiation. This increases the likelihood that the trouble will be addressed promptly and appropriately. Accordingly, the occurrence of trouble with customers during business negotiations can be reduced.

In the present embodiment, it has been described that part or all of the functions of the information processing device 20 are implemented in a terminal device. However, the information processing device 20 may be installed externally to a terminal device, and the information processing device 20 and a plurality of terminal devices installed at the dealership may execute processing while transmitting and receiving various types of data via the network 40. In this case, the information processing device 20 may be a computer, such as a server, that belongs to a cloud computing system or another computing system installed in a data center.

The present disclosure is not limited to the embodiment described above. For example, a plurality of blocks shown in the block diagram may be integrated, or a single block may be divided. Instead of executing the steps of the flowchart in chronological order as described above, the steps may be executed in parallel or in a different order depending on the processing capability of the device that executes the steps, or as necessary. Other modifications may be made without departing from the spirit and scope of the present disclosure.

What is claimed is:

1. An information processing device comprising a control unit, wherein the control unit is configured to
acquire negotiation information during a business negotiation with a customer by using one or more sensors,
determine, based on a result of analyzing the negotiation information using machine learning, whether there is a sign of trouble in the business negotiation, and
upon determining that there is the sign of trouble, send an alert to a specific terminal.

2. The information processing device according to claim 1, wherein the control unit is further configured to
refer to a database in which, for each of a plurality of vehicles, a model is registered in association with one or more attributes related to the model, and
analyze the negotiation information by comparing the negotiation information with the database using the machine learning.

3. The information processing device according to claim 2, wherein:
the negotiation information includes vehicle data indicating a model of a vehicle being considered in the business negotiation and a value of an attribute related to the model; and
the control unit is further configured to compare a spoken attribute value with a registered attribute value, and when the spoken attribute value differs from the registered attribute value, determine that there is the sign of trouble, the spoken attribute value being the value of the attribute that is spoken during the business negotiation and indicated in the vehicle data, and the registered attribute value being a value of the attribute that is registered in the database for the same model as the model indicated in the vehicle data.

4. The information processing device according to claim 1, wherein:
the negotiation information includes voice data obtained during the business negotiation; and
the control unit is further configured to, upon determining that there is the sign of trouble, generate a summary of the business negotiation from the voice data using natural language processing, and send the generated summary, as at least part of the negotiation information, together with the alert.

5. The information processing device according to claim 1, wherein:
the negotiation information includes biometric information of an employee obtained during the business negotiation; and
the control unit is further configured to determine that there is the sign of trouble when the biometric information satisfies a predetermined condition.
